(19) United States
(12) Patent Application Publication
(10) Pub. No.: US 2020/0008104 A1
(43) Pub. Date: Jan. 2, 2020

(54) METHOD FOR DETERMINING CHANNEL QUALITY INDICATOR CQI INDEX, USER EQUIPMENT, AND BASE STATION

(71) Applicant: Huawei Technologies Co., Ltd., Shenzhen (CN)

(72) Inventors: Chen Dong, Shenzhen (CN); Yanliang Sun, Beijing (CN); Jian Wang, Beijing (CN); Lili Zhang, Beijing (CN)

(21) Appl. No.: 16/089,203

(22) PCT Filed: Mar. 31, 2016
(86) PCT No.: PCT/CN2016/078028

§ 371 Date: Sep. 27, 2018

(51) Int. Cl. H04W 28/22; H04L 5/00; H04B 17/336; H04L 12/26

(52) U.S. Cl. CPC H04W 28/22; H04L 43/0894; H04B 17/336; H04L 5/0057

(57) ABSTRACT

In a method for determining a channel quality indicator (CQI) index, a user equipment (UE) determines quality of a channel between the UE and a base station. The UE sends a first index to the base station based on the quality of the channel. The first index is a CQI index corresponding to an average transmission rate supported by the channel. The UE sends an index difference to the base station based on the quality of the channel. The index difference indicates a difference between the first index and a second index. The second index is a CQI index corresponding to an instant transmission rate supported by the channel. A period for sending the first index is longer than a period for sending the index difference. A quantity of bits occupied by the index difference is less than a quantity of bits occupied by the first index.

### CROSS-REFERENCE TO RELATED APPLICATIONS

This application claims the benefit of International Application No. PCT/CN2016/078028, filed on Mar. 31, 2016, which application is hereby incorporated herein by reference in its entirety.

### TECHNICAL FIELD

The present invention relates to the communications field, and more specifically, to a method for determining a channel quality indicator (CQI) index, user equipment, and a base station.

### BACKGROUND

TS36.213 of the 3GPP R12 provides a table of a correspondence between a channel quality indicator (CQI), a modulation scheme, and a transmission rate. As shown in Table 1, CQI index numbers range from 0 to 15 (a CQI occupies 4 bits, and there are 16 ranges in total), the modulation scheme includes QPSK, 16QAM, and 64QAM, and the transmission rate ranges from 0 to 5.5547.

TABLE 1
Correspondence between CQI, modulation scheme, bit rate, and rate

| | Modulation | Bit rate × | |
|---|---|---|---|
| CQI | scheme | 1024 | Rate |
| 0 | — | — | — |
| 1 | QPSK | 78 | 0.1523 |
| 2 | QPSK | 120 | 0.2344 |
| 3 | QPSK | 193 | 0.377 |
| 4 | QPSK | 308 | 0.6016 |
| 5 | QPSK | 449 | 0.877 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

In the prior art, when user equipment (UE) communicates with the base station, the UE detects quality of a channel, calculates an instant transmission rate m supported by the channel, then determines, according to Table 1, a CQI index corresponding to a rate that is less than or equal to m and that is closest to m, and feeds back the CQI index to the base station. After receiving the CQI index fed back by the UE, the base station queries Table 1 to determine a modulation scheme and a transmission rate that are corresponding to the CQI index, and then transmits data to the UE by using the corresponding modulation scheme and at the corresponding transmission rate. Specifically, if the UE detects that the instant transmission rate supported by the channel is 0.8, two rates that are closest to the rate of 0.8 in Table 1 include the rate of 0.6016 corresponding to the CQI index 4 and the rate of 0.877 corresponding to the CQI index 5. Because only a rule of selecting a smaller value instead of a larger value can be used during feedback, the UE feeds back the CQI index 4 to the base station. After receiving the CQI index sent by the UE, the base station determines, according to Table 1, that a rate corresponding to the CQI index 4 is 0.6016 and a modulation scheme is QPSK. Then, the base station sends the data to the UE at the rate of 0.6016 by using the modulation scheme QPSK. In the prior art, the UE usually feeds back the CQI index to the base station periodically (for example, 10 ms is used as one period), and the base station determines, based on the received CQI index, a specific modulation scheme and a specific transmission rate that are used to send the data to the UE. A main prior-art problem is that relatively considerable channel resources are occupied when the UE periodically feeds back the CQI index to the base station, and signaling overheads are relatively high.

### SUMMARY

This application provides a method for determining a CQI index, user equipment, and a base station, to reduce control signaling overheads.

According to a first aspect, a method for determining a CQI index is provided. The method includes determining, by user equipment UE, quality of a channel between the UE and a base station. The method also includes sending, by the UE, a first index to the base station based on the quality of the channel. The first index is a CQI index corresponding to an average transmission rate supported by the channel. After sending the first index, the method also includes sending, by the UE, an index difference to the base station based on the quality of the channel, so that the base station determines a second index based on the first index and the index difference. The index difference is used to indicate a difference between the first index and the second index. The second index is a CQI index corresponding to an instant transmission rate supported by the channel. A period for sending the first index by the UE is longer than a period for sending the index difference by the UE. A quantity of bits occupied by the index difference is less than a quantity of bits occupied by the first index.

It should be understood that, after receiving the first index and the index difference that are sent by the UE, the base station may determine, based on the first index and the index difference, a CQI index corresponding to the channel between the base station and the UE, that is, the second index. In this way, the base station determines the CQI index corresponding to the channel. Next, the base station may determine, based on the CQI index, a rate, a modulation scheme, and a bit rate that are used to send data to the UE on the channel, and the like.

In the prior art, the UE feeds back the quality of the channel to the base station by periodically feeding back the CQI index. In this application, when the quality of the channel needs to be fed back to the base station, the UE feeds back the CQI index (that is, the first index) and the index difference to the base station. Because the index difference occupies a relatively small quantity of bits, signaling required for feeding back the CQI index can be reduced, and signaling overheads can be reduced.

With reference to the first aspect, in a first implementation of the first aspect, after a change in the average rate supported by the channel between the UE and the base station exceeds a specified threshold, the UE sends the first index to the base station again.

With reference to the first aspect or the first implementation of the first aspect, in a second implementation of the first aspect, the quantity of bits occupied by the index difference is less than 4 bits.

According to a second aspect, a method for determining a CQI index is provided. The method includes receiving, by a base station, a first index sent by user equipment UE. The first index is a CQI index corresponding to an average transmission rate supported by a channel between the base station and the UE. The method also includes receiving, by the base station, an index difference sent by the UE. The index difference is used to indicate a difference between the first index and a second index. The second index is a CQI index corresponding to an instant transmission rate supported by the channel. A period for sending the first index by the UE is longer than a period for sending the index difference by the UE. A quantity of bits occupied by the index difference is less than a quantity of bits occupied by the first index. The method further includes determining, by the base station based on the first index and the index difference, a CQI index corresponding to the channel.

In this application, when the quality of the channel needs to be fed back to the base station, the UE feeds back the CQI index (that is, the first index) and the index difference to the base station. Because the index difference occupies a relatively small quantity of bits, signaling required for feeding back the CQI index can be reduced, and signaling overheads can be reduced.

With reference to the second aspect, in a first implementation of the second aspect, the method further includes: determining, by the base station based on the CQI index corresponding to the channel, the instant transmission rate supported by the channel.

With reference to the second aspect or the first implementation of the second aspect, in a second implementation of the second aspect, the quantity of bits occupied by the index difference is less than 4 bits.

With reference to a third aspect, user equipment is provided, where the user equipment includes modules for performing the method in the first aspect.

According to a fourth aspect, a base station is provided, where the base station includes modules for performing the method in the second aspect.

According to a fifth aspect, user equipment is provided, where the user equipment includes a memory, a processor, and a transceiver, the memory is configured to store a program, and when the program is executed, the processor and the transceiver are configured to perform the method in the first aspect.

According to a sixth aspect, a base station is provided, where the base station includes a memory, a transceiver, and a processor, the memory is configured to store a program, and when the program is executed, the transceiver and the processor are configured to perform the method in the second aspect.

In some of the foregoing implementations, the first index and the index difference are sent to the base station by using a physical uplink control channel (PUCCH) or a physical uplink shared channel (PUSCH).

In some of the foregoing implementations, the UE obtains an average value of received channel quality measured on a side of the UE within a period of time before a current moment, to obtain average received channel quality, and determines, based on the average received channel quality, the average transmission rate supported by the channel.

In some of the foregoing implementations, the modulation scheme includes QPSK, 16QAM, 64QAM, and 256QAM.

In some of the foregoing implementations, the sending period of the first index is a first period, the sending period of the index difference is a second period, and the first period is at least longer than four times of the second period.

In some of the foregoing implementations, the period for sending the first index is between 1 ms and 100 s.

In some of the foregoing implementations, the period for sending the index difference is any one of 1 TTI, 2 TTIs, 7 TTIs, 1 ms, 2 ms, 5 ms, 10 ms, 20 ms, and 40 ms, and the TI is a transmission time interval. It should be understood that the period for sending the index difference may be another larger or smaller value.

It should be understood that the period for sending the first index may be a relatively longer time interval. Alternatively, the period for the first index may be less than or equal to 1 ms, or may be greater than or equal to 100 s.

In some of the foregoing implementations, both a quantity of antennas of the base station and a quantity of antennas of the UE are greater than or equal to 1.

In some of the foregoing implementations, a quantity of antennas of the base station ranges from 1 to 1024, and a quantity of antennas of the UE ranges from 1 to 8.

In some of the foregoing implementations, the method is applicable to a scenario in which a transmission time interval (TTI) is of any length.

In this application, when the quality of the channel needs to be fed back to the base station, the UE feeds back the CQI index (that is, the first index) and the index difference to the base station. Because the index difference occupies a relatively small quantity of bits, signaling required for feeding back the CQI index can be reduced, and signaling overheads can be reduced.

### BRIEF DESCRIPTION OF THE DRAWINGS

To describe the technical solutions in the embodiments of the present invention more clearly, the following briefly describes the accompanying drawings required for describing the embodiments of the present invention. Apparently, the accompanying drawings in the following description show merely some embodiments of the present invention, and persons of ordinary skill in the art may still derive other drawings from these accompanying drawings without creative efforts.

FIG. 1 is a schematic flowchart of a method for determining a CQI index according to an embodiment of the present invention;

FIG. 2 is a schematic block diagram of user equipment according to an embodiment of the present invention;

FIG. 3 is a schematic block diagram of a base station according to an embodiment of the present invention;

FIG. 4 is a schematic block diagram of user equipment according to an embodiment of the present invention; and

FIG. 5 is a schematic block diagram of a base station according to an embodiment of the present invention.

### DETAILED DESCRIPTION OF ILLUSTRATIVE EMBODIMENTS

The following clearly and completely describes technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

It should be understood that the technical solutions of the present invention may be applied to various communications systems, such as a Global System for Mobile Communications (GSM), a Code Division Multiple Access (CDMA) system, a Wideband Code Division Multiple Access (WCDMA) system, a general packet radio service (GPRS), a Long Term Evolution (LTE) system, a Long Term Evolution Advanced (LTE-A) system, a Universal Mobile Telecommunications System (UMTS), and 5G.

It should be further understood that in the embodiments of the present invention, user equipment (UE) includes but is not limited to a mobile station (MS), a mobile terminal, a mobile telephone, a handset, portable equipment, and the like. The user equipment may communicate with one or more core networks by using a radio access network (RAN). For example, the user equipment may be a mobile telephone (or referred to as a “cellular” telephone), or a computer having a wireless communication function. Alternatively, the user equipment may be a portable, pocket-sized, handheld, computer built-in, or in-vehicle mobile apparatus.

In the prior art, the UE usually measures quality of a channel periodically, to obtain an instant transmission rate supported by the channel, then queries Table 1 to determine a corresponding CQI index, and feeds back the CQI index to a base station. Generally, the quality of the channel is affected by two types of factors. The two types of factors herein are referred to as a large-scale characteristic and a small-scale characteristic of the channel. The large-scale characteristic is a main factor for determining the quality of the channel. The large-scale characteristic is mainly reflected by an average receiving signal-to-noise ratio of the channel. The large-scale characteristic is mainly determined based on factors, such as whether a transmit antenna has a direct transmission component, a distance between the transmit antenna and a receive antenna, and how many buildings a signal transmitted by the transmit antenna needs to penetrate to reach the receive antenna. These factors have relatively great impact on the quality of the channel. However, the large-scale characteristic changes very slowly. In a vast majority of application scenarios, if measurement is performed based on a time length of 320 ms to 100 s, the large-scale characteristic of the channel changes very slightly. Compared with the large-scale characteristic, the small-scale characteristic is a relatively secondary factor for determining the quality of the channel. The small-scale characteristic mainly includes factors such as fading and a shadow effect. These factors change relatively quickly. Therefore, the small-scale characteristic causes the quality of the channel to always fluctuate in a relatively small range. A fluctuation speed is related to a Doppler frequency, and is generally at a level of one millisecond to ten milliseconds. In the embodiments of the present invention, based on the foregoing characteristics of the channel, when a CQI is fed back, the large-scale characteristic and the small-scale characteristic of the channel are considered, and a first index and an index difference are fed back to the base station respectively based on the large-scale characteristic and the small-scale characteristic of the channel. However, when the first index is fed back, an average transmission rate supported by the channel is obtained based on the large-scale characteristic of the channel. Then, Table 1 is queried, a CQI index corresponding to the average transmission rate is used as the first index, and the first index is sent to the base station. However, when the index difference is fed back, an instant transmission rate supported by the channel is obtained based on the large-scale characteristic and the small-scale characteristic of the channel. Then, a difference between a second index corresponding to the instant transmission rate and the first index is determined, the index difference is then used to indicate the difference between the second index and the first index, and the index difference is fed back to the base station. Because the large-scale characteristic of the channel changes very slightly, that is, the average transmission rate supported by the channel fluctuates very slightly, the first index may be fed back in a relatively long time interval. However, a feedback period of the index difference is the same as a feedback period in the prior art. For example, the first index is fed back once every 320 ms, and the index difference is fed back once every 10 ms. The index difference actually indicates the difference between two index values, and the difference between the second index and the first index generally falls within a range of −4 to 3. Therefore, only 3 bits need to be occupied when the index difference is fed back. Compared with a prior-art manner of transmitting a CQI index, signaling overheads are reduced.

A method for determining a CQI index and an apparatus in the present invention are described below in detail with reference to specific embodiments.

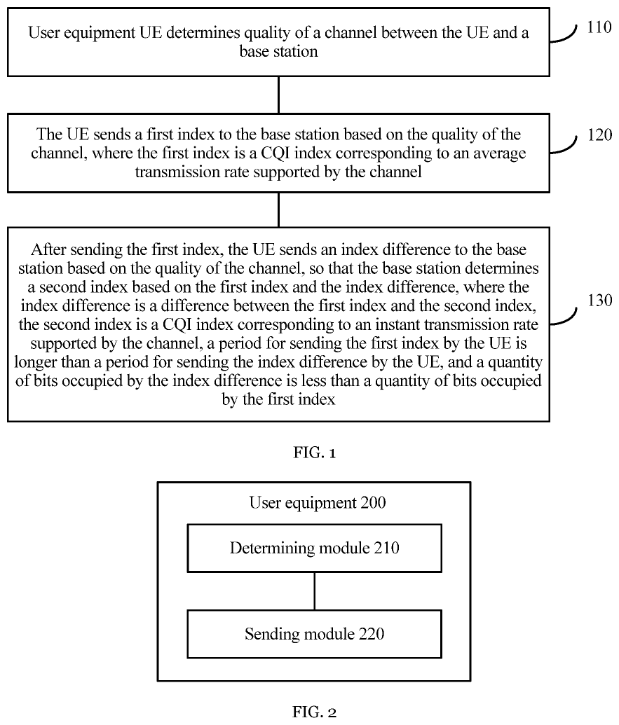

FIG. 1 is a schematic flowchart of a method for determining a CQI index according to an embodiment of the present invention. Steps of the method shown in FIG. 1 are described below in detail.

110: UE determines quality of a channel between the UE and a base station.

Specifically, because an average value of a small-scale characteristic is 0, the UE may obtain an average value of received channel quality measured on a side of the UE within a period of time before a current moment. In this way, impact of the small-scale characteristic may be averaged, and an average receiving signal-to-noise ratio corresponding to a large-scale characteristic remains. Then, an average transmission rate supported by the channel may be obtained according to Table 1. Finally, the large-scale characteristic and the small-scale characteristic are comprehensively measured, so that an instant transmission rate supported by the channel may be obtained.

120: The UE sends a first index to the base station based on the quality of the channel, where the first index is a CQI index corresponding to the average transmission rate supported by the channel between the UE and the base station.

The large-scale characteristic of the channel between the UE and the base station may be the average signal-to-noise ratio of the channel. In most of application scenarios, the average signal-to-noise ratio of the channel changes very slightly within a period of time (for example, from 320 ms to 100 s). The UE may calculate, based on a formula according to the average signal-to-noise ratio, the average transmission rate supported by the channel, then may determine, according to Table 1, the CQI index corresponding to the average transmission rate supported by the channel, uses the CQI index as the first index, and feeds back the CQI index to the base station.

It should be understood that the first index actually reflects the large-scale characteristic of the channel. Because the large-scale characteristic changes relatively slowly, the first index may be fed back once to the base station within a period T, and a time range of T may be from 320 ms to 100 seconds. In addition, when the first index is fed back, the first index may be fed back to the base station in a triggering manner instead of a periodically sending manner. For example, when average quality of the channel changes or a change in average quality exceeds a specified threshold, the UE sends the first index to the base station again. That is, after the average rate supported by the channel between the UE and the base station changes or a change exceeds the specified threshold, the UE sends the first index to the base station again; otherwise, the UE does not send the first index to the base station again. It should be further understood that the first index sent by the UE reflects an average transmission rate currently supported by the channel.

130: The UE sends an index difference to the base station according to the quality of the channel, where the index difference is used to indicate a difference between the first index and a second index, the second index is a CQI index corresponding to the instant transmission rate supported by the channel, a period for sending the first index by the UE is longer than a period for sending the index difference by the UE, and a quantity of bits occupied by the index difference is less than a quantity of bits occupied by the first index.

Specifically, the period for sending the first index by the UE may be 320 ms, and the period for sending the index difference may be 10 ms. The quantity of bits occupied by the first index may be 4 bits, and the quantity of bits occupied by the index difference is less than 4 bits. Preferably, the first index occupies 4 bits, and the index difference occupies 3 bits.

After receiving the first index and the index difference, the base station may determine, based on the first index and index difference, the instant transmission rate supported by the channel. Specifically, the base station may first determine the second index (that is, a CQI index corresponding to the channel) based on the first index and the index difference, and then determines, based on the second index, the instant transmission rate supported by the channel.

For example, when the first index is 6 and the index difference is 3, the base station first obtains the second index of 9 based on the first index and the index difference, and then queries Table 1, to determine that the instant transmission rate supported by the channel is 2.4063 and that a modulation scheme is 16QAM.

In this embodiment of the present invention, when the quality of the channel needs to be fed back to the base station, the UE feeds back the CQI index (that is, the first index) and the index difference to the base station. Because the index difference occupies a relatively small quantity of bits, signaling required for feeding back the CQI index can be reduced, and signaling overheads can be reduced.

The method for determining a CQI index in this embodiment of the present invention may be applied to a specific antenna configuration scenario. The method for determining a CQI index in this embodiment of the present invention is described below in detail with reference to Table 1 and Table 2 by using RI=1 as an example. Table 2 shows a correspondence between the index difference and the difference between the first index and the second index. It can be seen according to Table 2 that, when the difference between the first index and the second index is 0, 1, and 2, a value of the index difference is equal to the difference between the first index and the second index. However, when the difference between the first index and the second index is another value different from 0, 1, and 2, there is a correspondence between the index difference and the difference between the first index and the second index. Actually, Table 2 shows only one form of the correspondence in which the index difference indicates the difference between the first index and the second index. Alternatively, the index difference may indicate the difference between the first index and the second index in another form.

TABLE 2
Correspondence between index difference and difference between first
index and second index

| | Difference between first index and second |
|---|---|
| Index difference | index |
| 0 | 0 |
| 1 | 1 |
| 2 | 2 |
| 3 | ≥3 |
| 4 | ≤−4 |
| 5 | −3 |
| 6 | −2 |
| 7 | −1 |

Specific steps of feeding back, by the UE, the first index and the index difference to the base station and determining, by the base station based on the first index and the index difference that are fed back by the UE, the instant transmission rate supported by the channel and the corresponding modulation scheme and a corresponding bit rate are as follows:

201: The UE determines, based on the average receiving signal-to-noise ratio of the channel, that the average rate supported by the channel is 1.41; and the UE selects, according to Table 1, a rate of 1.1758 that is closest to the rate of 1.41 and that is less than the rate of 1.41, uses a CQI index 6 corresponding to 1.1758 as the first index, and sends the first index to the base station.

202: The UE obtains, based on instant quality of the channel, the instant transmission rate of 2.01 supported by the channel; selects, according to Table 1, a rate of 1.9141 that is closest to a rate of 2.01 and that is less than the rate of 2.01; determines that a second index corresponding to 1.9141 is 8; performs subtraction on the second index and the first index to obtain the difference of 2; then queries Table 2 to determine, based on the correspondence between the difference and the index difference, that the index difference is 2; and then feeds back the index difference to the base station.

203: The base station receives the first index and the index difference.

204: The base station determines, based on the index difference, that the difference between the first index and the second index is 2; then determines, based on the first index, that the second index is 8; and then queries Table 1 to determine that a transmission rate corresponding to the second index 8 is 1.9141, that the modulation scheme is 16QAM, and that the bit rate is 490; and in this way, the base station determines the instant transmission rate supported by the channel between the UE and the base station, the supported modulation scheme, and the bit rate.

205: The base station transmits data to the UE based on the instant transmission rate supported by the channel, the supported modulation scheme, and the bit rate that are obtained in step 204.

Specifically, a quantity of bits used in this embodiment of the present invention to feed back a CQI and a quantity of bits used in the prior art to feed back a CQI are compared below with reference to a specific example It is assumed that a communications system uses a 3GPP R12 standard, the UE feeds back a CQI to the base station once every 10 ms, an antenna configuration of the system is 8×2, eight antennas are on a side of the base station, two antennas are on a side of the UE, and an average receiving signal-to-noise ratio is 10.6 dB. That is, avgSNR=8e6. Herein, a time length of 320 ms is used to measure the quantity of bits occupied for sending the CQI in the prior art and the quantity of bits occupied for sending the CQI in this embodiment of the present invention. In the prior art, a quantity of bits occupied to feed back the CQI of the channel is 4 bits, the CQI of the channel is fed back to the base station once every 10 ms, and needs to be fed back 32 times in total within the time period of 320 ms. Therefore, in the prior art, information of 4×32=128 bits is accumulatively used when the CQI is fed back within 320 ms. However, in this embodiment of the present invention, the first index needs to be fed back only once within the time period of 320 ms, the first index occupies 4 bits, the index difference is fed back once every 10 ms, and the index difference occupies 3 bits. In this way, information of 3×32+4=100 bits is accumulatively used when the CQI is fed back within 320 ms. Therefore, the quantity of bits used for feeding back a CQI within 320 ms in the method for determining a CQI index in this embodiment of the present invention is 28 bits fewer than that in the prior art. That is, compared with the prior art, control signaling is reduced in this embodiment of the present invention.

It should be understood that, in this embodiment of the present invention, when the first index is determined, in addition to Table 1, the first index may be further determined according to Table 3. Table 3 is a table newly added to a 3GPP protocol as a communication rate becomes higher. A range of the rate included in Table 3 is wider than a range of the rate included in Table 4. When the first index is determined, Table 1 or Table 3 may be selectively used according to an actual situation.

TABLE 3
Correspondence between CQI, modulation scheme, bit rate, and rate

| CQI | Modulation scheme | Bit rate × 1024 | Rate |
|---|---|---|---|
| 0 | — | — | — |
| 1 | QPSK | 78 | 0.1523 |
| 2 | QPSK | 193 | 0.377 |
| 3 | QPSK | 449 | 0.877 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

The method for determining a CQI index in this embodiment of the present invention is described above in detail with reference to FIG. 1, FIG. 2, Table 1, Table 2, and Table 3. User equipment and a base station in the embodiments of the present invention are described below with reference to FIG. 2 to FIG. 5. It should be understood that the user equipment and the base station in FIG. 2 to FIG. 5 can implement steps of the foregoing method for determining a CQI index. For brevity, repeated descriptions are properly omitted.

FIG. 2 is a schematic block diagram of user equipment 200 according to an embodiment of the present invention. The user equipment 200 includes: a determining module 210, configured to determine quality of a channel between the user equipment 200 and a base station; and a sending module 220, configured to send a first index to the base station based on the quality of the channel, where the first index is a CQI index corresponding to an average transmission rate supported by the channel; where the sending module 220 is further configured to: after sending the first index, send an index difference to the base station based on the quality of the channel, so that the base station determines a second index based on the first index and the index difference, where the index difference is used to indicate a difference between the first index and the second index, the second index is a CQI index corresponding to an instant transmission rate supported by the channel, a period for sending the first index by the user equipment 200 is longer than a period for sending the index difference by the user equipment 200, and a quantity of bits occupied by the index difference is less than a quantity of bits occupied by the first index.

In this embodiment of the present invention, when the quality of the channel needs to be fed back to the base station, the UE feeds back the CQI index (that is, the first index) and the index difference to the base station. Because the index difference occupies a relatively small quantity of bits, signaling required for feeding back the CQI index can be reduced, and signaling overheads can be reduced.

Optionally, in an embodiment, the sending module 220 is further configured to: after a change in the average rate supported by the channel between the user equipment 200 and the base station exceeds a specified threshold, the sending module 220 sends the first index to the base station again.

Optionally, in an embodiment, the quantity of bits occupied by the index difference is less than 4 bits.

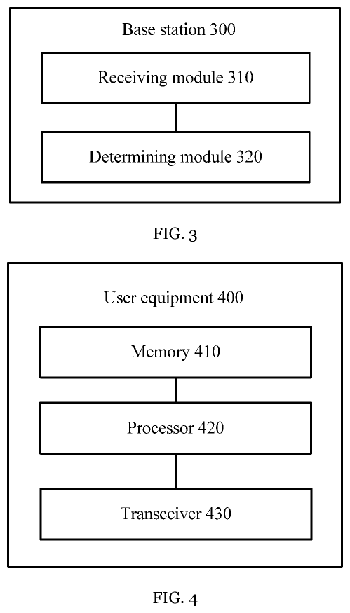

FIG. 3 is a schematic structural diagram of a base station 300 according to an embodiment of the present invention. The base station 300 includes: a receiving module 310, configured to receive a first index sent by user equipment UE, where the first index is a CQI index corresponding to an average transmission rate supported by a channel between the base station and the UE; where the receiving module 310 is further configured to receive an index difference sent by the UE, where the index difference is used to indicate a difference between the first index and a second index, the second index is a CQI index corresponding to an instant transmission rate supported by the channel, a period for sending the first index by the UE is longer than a period for sending the index difference by the UE, and a quantity of bits occupied by the index difference is less than a quantity of bits occupied by the first index; and a determining module 320, configured to determine, based on the first index and the index difference, a CQI index corresponding to the channel.

In this embodiment of the present invention, when the quality of the channel needs to be fed back to the base station, the UE feeds back the CQI index (that is, the first index) and the index difference to the base station. Because the index difference occupies a relatively small quantity of bits, signaling required for feeding back the CQI index can be reduced, and signaling overheads can be reduced.

Optionally, in an embodiment, the determining module 320 is further configured to determine, based on the CQI index corresponding to the channel, the instant transmission rate supported by the channel.

Optionally, in an embodiment, the quantity of bits occupied by the index difference is less than 4 bits.

FIG. 4 is a schematic structural diagram of user equipment 400 according to an embodiment of the present invention. The user equipment 400 includes: a memory 410, configured to store a program; a processor 420, where when the program is executed, the processor 420 is configured to determine quality of a channel between the user equipment 400 and a base station; and a transceiver 430, where when the program is executed, the transceiver 430 is configured to send a first index to the base station based on the quality of the channel, where the first index is a CQI index corresponding to an average transmission rate supported by the channel, where the transceiver 430 is further configured to: after sending the first index, send an index difference to the base station based on the quality of the channel, so that the base station determines a second index based on the first index and the index difference, where the index difference is used to indicate a difference between the first index and the second index, the second index is a CQI index corresponding to an instant transmission rate supported by the channel, a period for sending the first index by the user equipment 400 is longer than a period for sending the index difference by the user equipment 400, and a quantity of bits occupied by the index difference is less than a quantity of bits occupied by the first index.

In this embodiment of the present invention, when the quality of the channel needs to be fed back to the base station, the UE feeds back the CQI index (that is, the first index) and the index difference to the base station. Because the index difference occupies a relatively small quantity of bits, signaling required for feeding back the CQI index can be reduced, and signaling overheads can be reduced.

Optionally, in an embodiment, the processor 420 is specifically configured to: determine the second index based on the first index and the index difference; and determine, based on the second index, the instant transmission rate supported by the channel.

Optionally, in an embodiment, the quantity of bits occupied by the index difference is less than 4 bits.

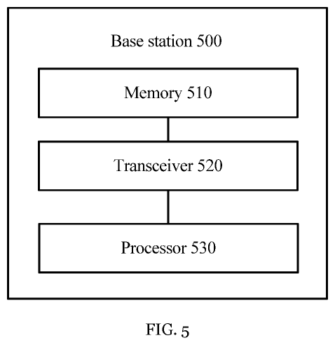

FIG. 5 is a schematic structural diagram of a base station 500 according to an embodiment of the present invention. The base station 500 includes: a memory 510, configured to store a program; a transceiver 520, where when the program is executed, the transceiver 520 is configured to receive a first index sent by user equipment UE, where the first index is a CQI index corresponding to an average transmission rate supported by a channel between the base station 500 and the UE, where the transceiver 520 is further configured to receive an index difference sent by the UE, where the index difference is used to indicate a difference between the first index and a second index, the second index is a CQI index corresponding to an instant transmission rate supported by the channel, a period for sending the first index by the UE is longer than a period for sending the index difference by the UE, and a quantity of bits occupied by the index difference is less than a quantity of bits occupied by the first index; and a processor 530, where when the program is executed, the processor 530 is configured to determine, based on the first index and the index difference, a CQI index corresponding to the channel.

In this embodiment of the present invention, when the quality of the channel needs to be fed back to the base station, the UE feeds back the CQI index (that is, the first index) and the index difference to the base station. Because the index difference occupies a relatively small quantity of bits, signaling required for feeding back the CQI index can be reduced, and signaling overheads can be reduced.

Optionally, in an embodiment, the processor 530 is further configured to determine, based on the first index and the index difference, the CQI index corresponding to the channel.

Optionally, in an embodiment, the quantity of bits occupied by the index difference is less than 4 bits.

Persons of ordinary skill in the art may be aware that the units and algorithm steps in the examples described with reference to the embodiments disclosed in this specification may be implemented by electronic hardware or a combination of computer software and electronic hardware. Whether the functions are performed by hardware or software depends on particular applications and design constraint conditions of the technical solutions. Persons skilled in the art may use different methods to implement the described functions for each particular application, but it should not be considered that the implementation goes beyond the scope of the present invention.

It may be clearly understood by persons skilled in the art that, for the purpose of convenient and brief description, for a detailed working process of the system, apparatus, and unit, refer to a corresponding process in the method embodiments. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The software product is stored in a storage medium, and includes several instructions for instructing a computer device (which may be a personal computer, a server, a network device, or the like) to perform all or some of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

The descriptions are only specific implementations of the present invention, but are not intended to limit the protection scope of the present invention. Any variation or replacement readily figured out by persons skilled in the art within the technical scope disclosed in the present invention shall fall within the protection scope of the present invention. Therefore, the protection scope of the present invention shall be subject to the protection scope of the claims.

1-12. (canceled)

13. A method, comprising:
determining, by a user equipment (UE), a quality of a channel between the UE and a base station;
sending, by the UE, a first index to the base station according to the quality of the channel, wherein the first index is a channel quality indicator (CQI) index corresponding to an average transmission rate supported by the channel; and
after sending the first index, sending, by the UE, an index difference to the base station according to the quality of the channel;
wherein a second index can be determined by the base station according to the first index and the index difference; and
wherein the index difference indicates a difference between the first index and the second index, the second index is a CQI index corresponding to an instant transmission rate supported by the channel, a period for sending the first index by the UE is longer than a period for sending the index difference by the UE, and a quantity of bits occupied by the index difference is less than a quantity of bits occupied by the first index.

14. The method according to claim 13, further comprising:
resending, by the UE, the first index to the base station when the average transmission rate supported by the channel between the UE and the base station changes beyond a specified threshold.

15. The method according to claim 13, wherein the quantity of bits occupied by the index difference is less than 4.

16. The method according to claim 13, wherein determining the quality of the channel comprises:
obtaining, by the UE, an average value of received channel quality measured on a side of the UE within a period of time before a current moment.

17. The method according to claim 13, further comprising:
calculating, by the UE, according to an average signal-to-noise ratio, the average transmission rate supported by the channel; and
determining, by the UE, the CQI index corresponding to the average transmission rate supported by the channel.

18. The method according to claim 13, wherein sending the first index comprises sending the first index using a physical uplink control channel (PUCCH) or a physical uplink shared channel (PUSCH); and
wherein sending the index difference comprises sending the index differing using the PUCCH or the PUSCH.

19. A method, comprising:
receiving, by a base station, a first index sent by a user equipment (UE), wherein the first index is a channel quality indicator (CQI) index corresponding to an average transmission rate supported by a channel between the base station and the UE;
receiving, by the base station, an index difference sent by the UE, wherein the index difference indicates a difference between the first index and a second index, wherein the second index is a CQI index corresponding to an instant transmission rate supported by the channel, a period for sending the first index by the UE is longer than a period for sending the index difference by the UE, and a quantity of bits occupied by the index difference is less than a quantity of bits occupied by the first index; and
determining, by the base station, a CQI index corresponding to the channel, according to the first index and the index difference.

20. The method according to claim 19, further comprising:
determining, by the base station, the instant transmission rate supported by the channel, according to the CQI index corresponding to the channel.

21. The method according to claim 20, further comprising:
determining, by the base station, a bit rate and a modulation scheme, according to the CQI index corresponding to the channel.

22. The method according to claim 19, wherein the quantity of bits occupied by the index difference is less than 4.

23. A user equipment (UE), comprising:
a processor;
a non-transitory computer-readable storage medium storing a program to be executed by the processor, the program including instructions to determine a quality of a channel between the UE and a base station; and
a transceiver, configured to:
send a first index to the base station according to the quality of the channel, wherein the first index is a CQI index corresponding to an average transmission rate supported by the channel; and
after sending the first index, send an index difference to the base station according to the quality of the channel, wherein the base station can determine a second index according to the first index and the index difference;
wherein the index difference indicates a difference between the first index and the second index, the second index is a CQI index corresponding to an instant transmission rate supported by the channel, a period for sending the first index by the UE is longer than a period for sending the index difference by the UE, and a quantity of bits occupied by the index difference is less than a quantity of bits occupied by the first index.

24. The UE according to claim 23, wherein the transceiver is further configured to:
after a change in the average transmission rate supported by the channel between the UE and the base station exceeds a specified threshold, send the first index to the base station again.

25. The UE according to claim 23, wherein the quantity of bits occupied by the index difference is less than 4.

26. The UE according to claim 23, wherein the instructions to determine the quality of the channel comprises instructions to:
obtain an average value of received channel quality measured on a side of the UE within a period of time before a current moment.

27. The UE according to claim 23, wherein the program further includes instructions to:
calculate, according to an average signal-to-noise ratio, the average transmission rate supported by the channel; and
determine the CQI index corresponding to the average transmission rate supported by the channel.

28. The UE according to claim 23, wherein the transceiver is configured to send the first index by sending the first index using a physical uplink control channel (PUCCH) or a physical uplink shared channel (PUSCH); and
wherein the transceiver is configured to send the index difference by sending the index difference using the PUCCH or the PUSCH.

29. A base station, comprising:
a transceiver, configured to:
receive a first index sent by a user equipment (UE), wherein the first index is a CQI index corresponding to an average transmission rate supported by a channel between the base station and the UE; and
receive an index difference sent by the UE, wherein the index difference indicates a difference between the first index and a second index, the second index is a CQI index corresponding to an instant transmission rate supported by the channel, a period for sending the first index by the UE is longer than a period for sending the index difference by the UE, and a quantity of bits occupied by the index difference is less than a quantity of bits occupied by the first index;
a processor; and
a non-transitory computer-readable storage medium storing a program to be executed by the processor, the program including instructions determine, according to the first index and the index difference, a CQI index corresponding to the channel.

30. The base station according to claim 29, wherein the program includes further instructions to:
determine, according to the CQI index corresponding to the channel, the instant transmission rate supported by the channel.

31. The base station according to claim 30, wherein the program includes further instructions to:
determine a bit rate and a modulation scheme, according to the CQI index corresponding to the channel.

32. The base station according to claim 29, wherein the quantity of bits occupied by the index difference is less than 4.
